(19) United States
(12) Patent Application Publication
(10) Pub. No.: US 2007/0061555 A1
(43) Pub. Date: Mar. 15, 2007

(54) Call return tracking technique

(76) Inventors: Michael St. Clair, Portland, OR (US); Boyd Phelps, Hillsboro, OR (US); Stephan Jourdan, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/229,177

(22) Filed: Sep. 15, 2005

(51) Int. Cl. G06F 9/44

(52) U.S. Cl. 712/242

(57) ABSTRACT

Method, apparatus, and system for tracking call returns. At least one embodiment maps the locations of a return instruction pointer within a speculative return stack buffer and a committed return stack buffer to determine a return stack buffers from which the return instruction pointer should be retrieved.

### BACKGROUND

1. Field

The present disclosure pertains to the field of microprocessors and microprocessor systems. Some embodiments relate to a technique to track call returns in a program that may be executed by a processor or processors, such as an out-of-order execution processor.

2. Description of Related Art

In typical microprocessor architectures, a software procedure, such as one embodied in a sequence of instructions or sub-instructions (“uOps”) (hereafter referred generically as “instructions”) native to a particular processor architecture (“machine code”), may invoke, or “call”, subroutines to perform various tasks. Typically, a return instruction address (“pointer”), indicating an instruction to where in program order execution is to resume following a called subroutine, is saved (“pushed”) to a memory location, such as a “stack”, and later restored (“popped”) when the subroutine completes so that execution may resume at the instruction indicated by the return instruction pointer.

In some microprocessor architectures, such as those that execute instructions in an out-of-order fashion, a return from a subroutine to an instruction indicated by the return instruction pointer may occur before the return instruction pointer has been stored in the stack. To accommodate this scenario, a copy of the return instruction pointer may be stored in a buffer (“return stack buffer”) before the return instruction pointer is stored in the stack, such that the return instruction pointer may be retrieved in the event of a return occurring before the return instruction pointer is stored in the stack.

As software programs have grown more complex, including the use of multiple instruction streams, or “threads”, that may be performed concurrently by the same processing resources, tracking subroutine return instructions and the call instructions to which they correspond, and therefore the corresponding return instruction pointer, has become increasingly difficult. The problem is exacerbated in out-of-order microprocessor architectures that use branch prediction to make early judgments as to whether a software branch, such as a “jump” operation, will be taken, because each predicted branch may include other call instructions to other subroutines having corresponding return instructions. If a branch is mispredicted, it can be difficult to efficiently determine the proper chain of calls and returns and corresponding return instruction pointers, such that execution of the program is returned to the proper place in program order from where the misprediction occurred.

To accommodate mispredictions of branch operations within programs containing a number of call and return instructions, the return stack buffer has been logically or physically divided into a “speculative return stack buffer” (SRSB) and a “committed/retired return stack buffer” (CRSB). FIG. 1, for example, illustrates a 2-part return stack buffer comprising an SRSB and a CRSB. The SRSB contains return instruction pointers corresponding to calls that have yet to be retired, or otherwise committed to machine state. The top-of-stack (TOS) of the SRSB and the CRSB is indicated by a TOS pointer that always points to the last return instruction pointer pushed onto the top of the stack, similar to a first-in-last-out (FILO) queue or buffer. Only when (if ever) the return instruction pointers stored in the SRSB become retired/committed are they stored in the CRSB, and in a similar fashion as they were stored in the SRSB.

Unfortunately, prior art stack buffer architectures, such as the one illustrated in FIG. 1 become difficult to manage as the number of calls and predictions nested within a thread of instructions becomes greater. For example, as the number of predicted jumps increases within an instruction thread, so does the possibility of mispredicted branches. Moreover, if the predicted targets of mispredicted branches (“mispredicted branches”) cause a corresponding return instruction target to be pushed into the SRSB or CRSB, it may be difficult to recover from a misprediction, causing the processor state and stack buffers to be flushed and the instruction thread to be re-executed from a location of known state.

One particular reason for the difficulty in recovering from mispredictions in some prior art stack buffer architectures is that a decision must be made as to whether the correct return instruction target is stored in the SRSB or the CRSB. Because it's not always possible to know when and whether a call to which a stored return instruction target corresponds is retired or otherwise committed to machine state, incorrect data may be read from one of the RSBs. This can result in performance degradation, especially as the complexity of code increases.

### BRIEF DESCRIPTION OF THE FIGURES

The present invention is illustrated by way of example and not limitation in the Figures of the accompanying drawings.

FIG. 1 illustrates a prior art return stack buffer architecture.

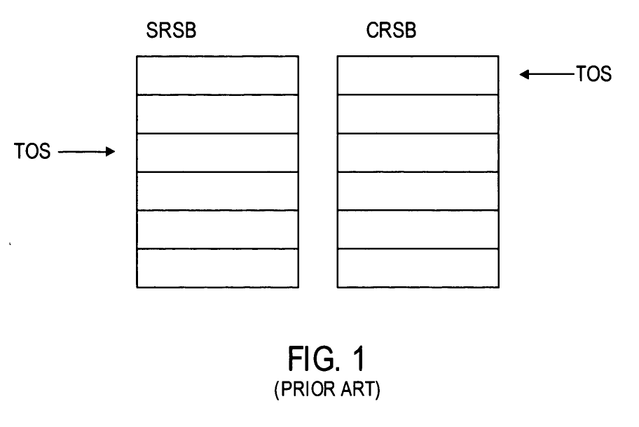

FIGS. 2a and 2b illustrate an example call and return sequence according to one embodiment of the invention.

FIG. 3 is a flow diagram illustrating operations according to one embodiment of the invention.

FIG. 4 illustrates a TOS array and corresponding logic that may be used in one embodiment of the invention.

FIG. 5 illustrates a front-side-bus (FSB) computer system in which one embodiment of the invention may be used.

FIG. 6 illustrates a point-to-point (PtP) computer system in which one embodiment of the invention may be used.

### DETAILED DESCRIPTION

The following description describes embodiments of a technique to track call returns. More particularly, at least one embodiment of the invention is described herein, in which return instruction pointers stored in a speculative return stack buffer (SRSB) are mapped to corresponding return instruction pointers stored in a committed return stack buffer (CRSB) in order to determine which buffer contains the proper return instruction pointer to return execution of a program to its proper place in program order. For example, in one embodiment, if a return instruction pointer is stored in the SRSB but not in the CRSB, as indicated by the mapping between the SRSB entries and CRSB entries, then the desired return instruction pointer from the SRSB is used to return execution to the proper place in program order. On the other hand, if the return instruction pointer is stored in the CRSB, then the desired return instruction pointer from the CRSB is used to return execution to the proper place in program order.

In the following description, numerous specific details such as processor types, microarchitectural conditions, events, enablement mechanisms, and the like are set forth in order to provide a more thorough understanding of the present invention. It will be appreciated, however, by one skilled in the art that the invention may be practiced without such specific details. Additionally, some well known structures, circuits, and the like have not been shown in detail to avoid unnecessarily obscuring the present invention.

At least some embodiments of the invention use a stack buffer containing two portions (or alternatively two separate stacks) to store speculative return instruction pointers and committed/retired return instruction pointers, respectively. Furthermore, at least one embodiment uses an SRSB and CRSB in conjunction with a speculative top-of-stack (STOS) pointer and a committed/retired top-of-stack (CTOS) pointer, respectively, to indicate and track the latest return instruction pointers stored within the SRSB and CRSB. In some embodiments, the STOS and CTOS pointers always point to the physical “top” entry of the SRSB and CRSB, respectively, such that the return instruction pointers are popped from the top entry of the stack. In other embodiments, the STOS and CTOS pointers indicate other entries in the SRSB and CRSB, respectively, depending upon in which entry the latest return instruction pointer is stored. For example, at least one embodiment stores return instruction pointers within the SRSB and CRSB in a sequential fashion and updates the pointers to indicate the entry that has most recently been stored. In another embodiment, one of the RSBs, such as the SRSB, is indexed in a sequential fashion, whereas the other RSB may be indexed in a fashion similar to a stack or FILO buffer. The choice of whether to index an RSB sequentially or in a “stack” manner, can influence performance and accuracy of the indexing. For this reason, some embodiments may use various combinations of indexing techniques among the RSBs according to the performance and accuracy goals of the particular application of one or more embodiments.

In at least one embodiment, a return instruction pointer corresponding to a call operation is chosen according to whether the return instruction pointer is reflected in the CRSB or only the SRSB, such that a decision can be made as to which RSB from which the return instruction pointer should be obtained without causing a machine or CRB flush in the case of a mispredicted branch instruction. In one embodiment, an M×N table may be used to map up to M number of SRSB entries and up to N number of CRSB entries, so that only SRSB entries corresponding to CRSB entries storing a desired return instruction pointer are accessed to obtain the desired return instruction pointer.

In one embodiment, M and N are equal, whereas in other embodiments they may be unequal. Furthermore, in one embodiment of the invention, M and N are both 8, such that an 8×8 single bit table may be formed to indicate SRSB and CRSB entries sharing a return instruction pointer. In other embodiments, other values may be chosen for M and N, such as 16.

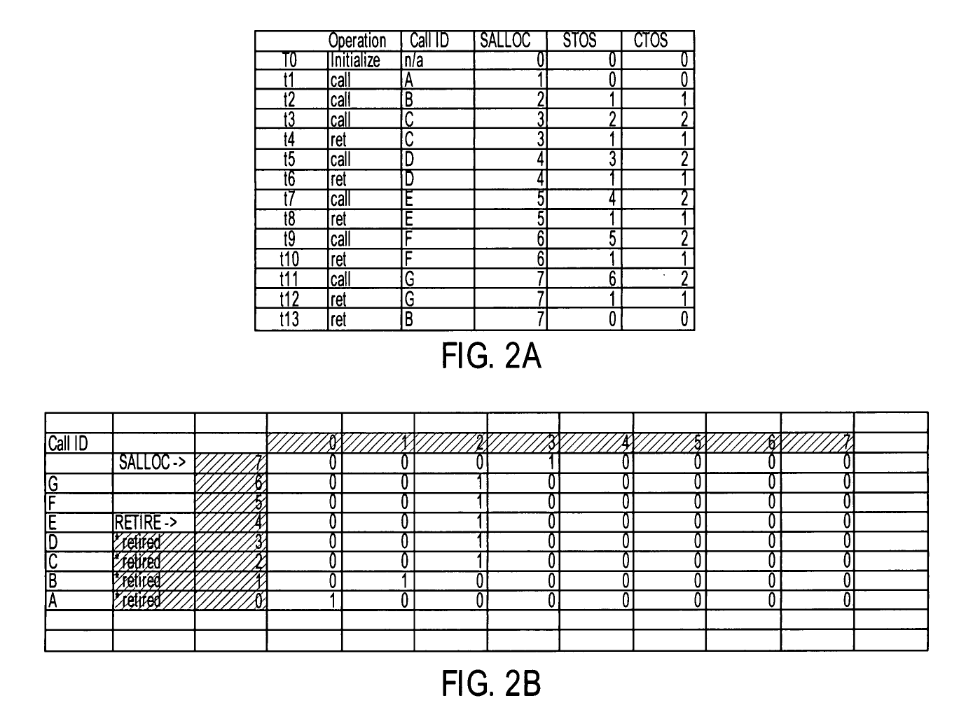

FIG. 2a and FIG. 2b illustrate an example call and return sequence and the corresponding mapping table to indicate SRSB and CRSB entries sharing a return instruction pointer. In one embodiment, the SRSB and CRSB entry storing a desired a return instruction pointer may be collectively referred to as the “top of the stack” (TOS), such that the table of FIG. 2b is effectively a TOS table or array. FIGS. 2a and 2b illustrate only one example of a call/return sequence and corresponding TOS array. Other examples may include more or fewer call or return operations and/or more or fewer TOS array columns or rows.

The table of FIG. 2a illustrates a sequence of call and returns at various instances (“t1”-“t13”) 201 and the corresponding entry numbers 205 allocated in the SRSB (indicated in the “SALLOC” column) to store the various return instruction pointers. Also shown in FIG. 2a are entry numbers 210 of the SRSB storing the STOS at particular instances and entry numbers 215 of the CRSB storing the CTOS at particular instances. Also illustrated in FIG. 2a is a column containing letters, A-G, 220 corresponding to the 8 entries of an SRSB in one embodiment of the invention. In other embodiments, more or fewer entries may be included in the SRSB.

For example, at an instance, such as t2, a call operation is performed, causing entry 2 of the SRSB to be allocated and the entry allocated from the previous instance (t1) to be indicated by STOS and CTOS. Similarly, at t3, another call is made that causes the 3^{rd} entry of the SRSB to be allocated and the entry allocated from t2 to be indicated by STOS and CTOS for the SRSB and CRSB, respectively. However, at t4, when a return operation is performed, SALLOC continues to point to the 3^{rd} entry of the SRSB, since no new return instruction pointer is being stored in either RSB, and the 1^{st} entry in the SRSB and CRSB are indicated by STOS and CTOS, respectively, since the 2^{nd} entry contains the return instruction pointer used by the return operation and therefore is no longer valid.

In one embodiment, the TOS array 225 of FIG. 2b maps and tracks all valid (committed or retired) SRSB entries to their corresponding CTOS value, illustrated in FIG. 2a. For example, at one instance (e.g., “t8”), we may assume that calls A-D (occurring at instances t1-t7 in FIG. 2a) in FIG. 2b have all retired and a return operation is predicted to occur at an instance corresponding to call “E”, by a branch prediction unit (BPU), for example. In this case, an RSB may be read according to the table of FIG. 2b, such that it can be determined whether a desired return instruction pointer is present at an entry in the SRSB (whose entries correspond to the rows of FIG. 2b) and the CRSB (whose entries correspond to the columns of FIG. 2b).

In order to determine which or whether a particular SRSB may contain a desired return instruction pointer corresponding to a particular CRSB entry, a mask vector may be created whose entries correspond to valid (i.e., entries appearing in the SRSB that do not correspond to calls that have been retired) SRSB and CRSB entries between the SALLOC pointer 230 and the RETIRE pointer 235 of FIG. 2b. For example, in FIG. 2b, the mask vector may contain the values “011100000”, in one embodiment, to indicate that SRSB entries E, F, and G, corresponding to the number of table entries from the SALLOC pointer to the RETIRE pointer, are valid entries. In one embodiment, the mask vector may be AND'ed with the columns of FIG. 2b (e.g., column 1 AND'ed with the mask vector is 01110000 AND 00000010=00000000). In one embodiment, the AND operation result values may be OR'ed with each other to determine whether any entry in the SRSB and CRSB contain the desired return instruction pointer. For example, the OR'ing of the AND operation result values above would be “0”, which may indicate that a return instruction pointer corresponding to entry “B” should be obtained from the CRSB at entry 1 (corresponding to column 1 and row “B” of the table of FIG. 2b), because the return instruction pointer corresponding to return operation at instance “B” (“t13” in FIG. 2a) is present in the CRSB (indicating that call “B” has retired) and is the best place to get the data.

As another example, consider the return operation at “t4” in FIG. 2a. At t4 we may assume that no prior calls have retired and a return operation at call C, in FIG. 2b, is predicted. Again, column 1 in the TOS array of FIG. 2b may be examined, since it corresponds to entry 1 indicated by CTOS at instance t4 in FIG. 2a. The mask vector may be equal to “00000111” in this case, indicating valid SRSB entries corresponding to table rows A-C (SALLOC allocating another SRSB at D). The mask vector may be AND'ed with column 1 (00000010 AND 00000111=00000010), and the result values OR'ed together, which equals 1. The 1 may indicate that the next return, if not preceded by a call, should be read from the SRSB at entry 1.

The mask vector may be generated in various embodiments in numerous ways. For example, in one embodiment the mask vector is generated by logic, software, or some combination thereof that performs an algorithm illustrated by the following pseudo-code:

IF Salloc == Retire THEN Mask = ′0
ELSE IF Salloc−1 > Retire THEN
MASK = Thermal_Decode_Salloc−1 XOR
Thermal_Decode_Retire−1
ELSE ( Salloc−1 < Retire) THEN
MASK = Thermal_Decode_Retire−1 XNOR
Thermal_Decode_Salloc−1
Retire on Queue −1

The above pseudo-code essentially determines whether a TOS array column contains valid entries between a pointer (“RETIRE”) indicating the most recently retired call operation and a SRSB entry allocation pointer (“SALLOC”). In other embodiments, a different algorithm may be used to determine the valid entries between the RETIRE and SALLOC pointers.

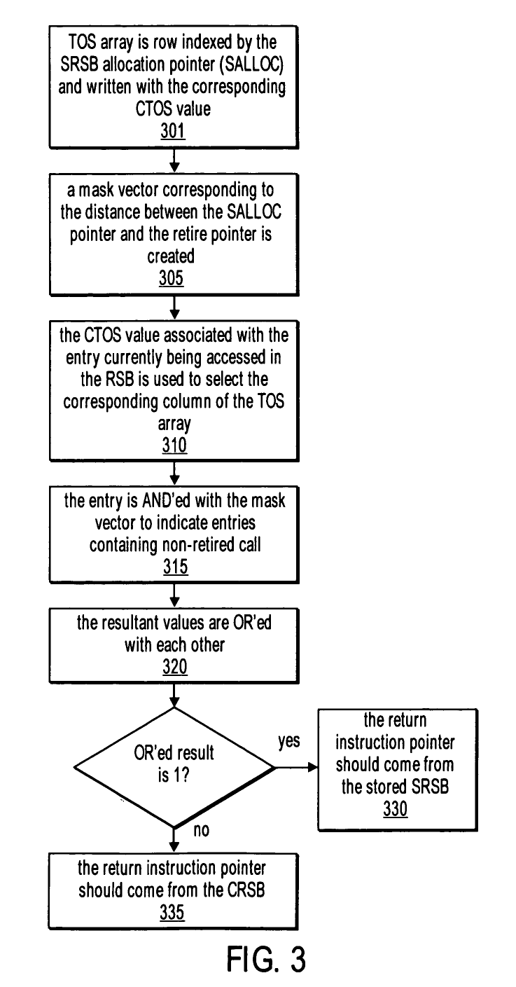

FIG. 3 is a flow diagram illustrating operations to determine which of the SRSB or CRSB (if either) from which a desired return instruction pointer should be retrieved. At operation 301, whenever a call operation occurs the TOS array is row indexed by the SRSB allocation pointer (SALLOC) and written with the corresponding CTOS value. At operation 305, a mask vector corresponding to the distance between the SALLOC pointer and the retire pointer is created. The retire pointer may indicate the array entry corresponding to the most recently retired call operation. In one embodiment, the mask vector represents all SRSB entries that have not yet retired and only exist in the SRSB (i.e. “valid” entries). At operation 310, the CTOS value associated with the entry currently being accessed in the RSB (i.e., desired return instruction pointer) is used to select the corresponding column of the TOS array. At operation 315, the entry is AND'ed with the mask vector to indicate entries containing non-retired calls, and at operation 320, the resultant values are OR'ed with each other. At operation 325, it is determined whether the OR'ed result is 1. If so, then at operation 330, the return instruction pointer should come from the stored SRSB. Otherwise, at operation 335, the return instruction pointer should come from the CRSB.

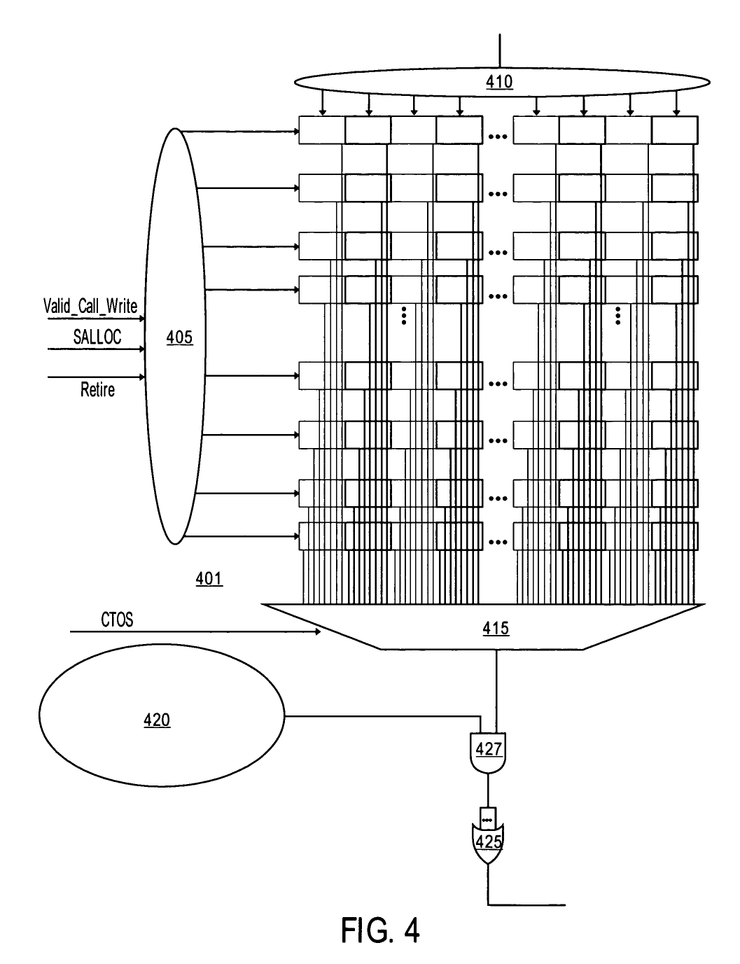

FIG. 4 illustrates a TOS array and corresponding logic that may be used in one embodiment of the invention. FIG. 4 illustrates a storage array 401 to store information illustrated in the rows and columns of the TOS array illustrated in FIG. 2b. If a call operation occurs in a program, the call operation, along with the SALLOC pointer and retired pointer, are decoded by row logic 405 to select one of the rows of the array to which the STOS pointer will correspond. Likewise, a CTOS pointer is decoded by column decode logic 410 to select one of the columns of the array.

The CTOS pointer will also select MUX 415 to choose among the column and row selected by CTOS and STOS, respectively, the result of which is AND'ed with a mask vector generated by mask vector generation logic 420. The resulting values of the AND operation 427 are OR'ed together by OR logic 425, from which a TOS selector will be generated to indicate whether the desired return instruction is to be obtained from the CRSB or the SRSB. In other embodiments, other logic may be used. Furthermore, in other embodiments, software may implement some or all of the TOS array logic illustrated in FIG. 4.

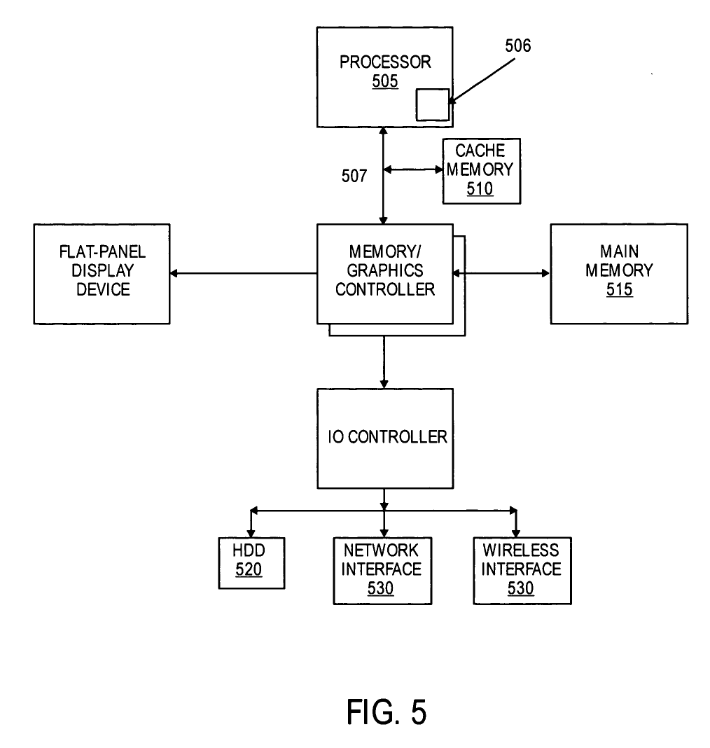

FIG. 5 illustrates a front-side-bus (FSB) computer system in which one embodiment of the invention may be used. A processor 505 accesses data from a level one (L1) cache memory 510 and main memory 515. In other embodiments of the invention, the cache memory may be a level two (L2) cache or other memory within a computer system memory hierarchy. Furthermore, in some embodiments, the computer system of FIG. 5 may contain both a L1 cache and an L2 cache.

Illustrated within the processor of FIG. 5 is a storage area 506 for machine state. In one embodiment storage area may be a set of registers, whereas in other embodiments the storage area may be other memory structures. Also illustrated in FIG. 5 is a storage area 507 for save area segments, according to one embodiment. In other embodiments, the save area segments may be in other devices or memory structures. The processor may have any number of processing cores. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 520, or a memory source located remotely from the computer system via network interface 530 containing various storage devices and technologies. The cache memory may be located either within the processor or in close proximity to the processor, such as on the processor's local bus 507.

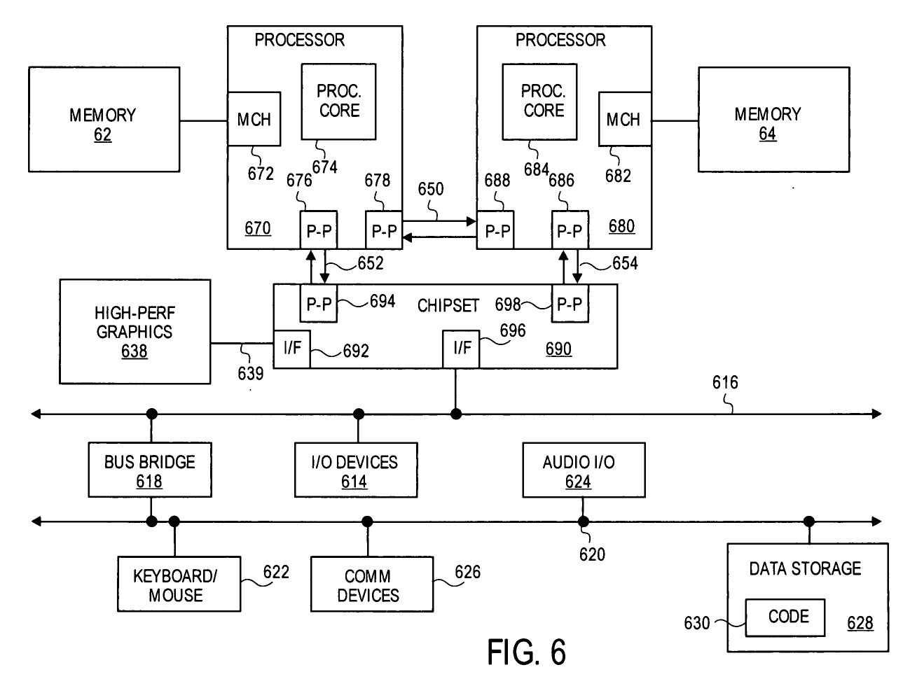

Furthermore, the cache memory may contain relatively fast memory cells, such as a six-transistor (6T) cell, or other memory cell of approximately equal or faster access speed. The computer system of FIG. 5 may be a point-to-point (PtP) network of bus agents, such as microprocessors, that communicate via bus signals dedicated to each agent on the PtP network. FIG. 6 illustrates a computer system that is arranged in a point-to-point (PtP) configuration. In particular, FIG. 6 shows a system where processors, memory, and input/output devices are interconnected by a number of point-to-point interfaces.

The system of FIG. 6 may also include several processors, of which only two, processors 670, 680 are shown for clarity. Processors 670, 680 may each include a local memory controller hub (MCH) 672, 682 to connect with memory 22, 24. Processors 670, 680 may exchange data via a point-to-point (PtP) interface 650 using PtP interface circuits 678, 688. Processors 670, 680 may each exchange data with a chipset 690 via individual PtP interfaces 652, 654 using point to point interface circuits 676, 694, 686, 698. Chipset 690 may also exchange data with a high-performance graphics circuit 638 via a high-performance graphics interface 639. Embodiments of the invention may be located within any processor having any number of processing cores, or within each of the PtP bus agents of FIG. 6.

Other embodiments of the invention, however, may exist in other circuits, logic units, or devices within the system of FIG. 6. Furthermore, in other embodiments of the invention may be distributed throughout several circuits, logic units, or devices illustrated in FIG. 6.

During development, a design may go through various stages, from creation to simulation to fabrication. Data representing a design may represent the design in a number of manners. First, as is useful in simulations, the hardware may be represented using a hardware description language or another functional description language Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) embodying techniques of the present invention.

Thus, techniques for call return tracking are disclosed. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
a storage array to store an indicator of whether a return instruction pointer corresponds to a speculatively predicted routine call operation or whether the return instruction pointer corresponds to a retired routine call operation.

2. The apparatus of claim 1, wherein rows of the storage array are to be indexed according to an allocation pointer to indicate allocated entries within a speculative return stack buffer (SRSB).

3. The apparatus of claim 2, wherein columns of the storage array are to be indexed according to top-of-stack pointer to indicate a most-recently stored return instruction pointer stored within a committed return stack buffer (CRSB).

4. The apparatus of claim 3, further comprising a mask generation logic to generate a mask to indicate the number of valid storage array entries between a first storage array entry corresponding to the allocation pointer and a second storage array entry corresponding to a most recently retired call operation.

5. The apparatus of claim 4 further comprising an AND logic to perform a Boolean AND operation between the mask and a column of storage entries selected by the top-of-stack pointer.

6. The apparatus of claim 5 further comprising an OR logic to perform a Boolean OR operation between values generated by the AND operation.

7. The apparatus of claim 6, wherein if the result of the OR operation is a first value, the return instruction pointer is to be retrieved from the SRSB, and wherein if the result of the OR operation is a second value, the return instruction pointer is to be retrieved from the CRSB.

8. A system comprising:
a memory to store at least one instruction, which if executed by a processor causes the processor to perform a call operation;
a top-of-stack (TOS) array to indicate likely locations of a return instruction pointer corresponding to the call operation;
a call return tracking logic to control the TOS array and to update the TOS array as a result of the processor performing the call operation.

9. The system of claim 8 further comprising a speculative return stack buffer (SRSB) to store the return instruction pointer if the call operation is speculatively executed by the processor.

10. The system of claim 9 further comprising a committed return stack buffer (CRSB) to store the return instruction pointer if the call operation is retired by the processor.

11. The system of claim 10 wherein rows of the storage array are to be indexed according to an allocation pointer to indicate allocated entries within the SRSB.

12. The system of claim 11, wherein columns of the storage array are to be indexed according to top-of-stack pointer to indicate a next return instruction pointer to be read from the CRSB.

13. The system of claim 12, further comprising a mask generation logic to generate a mask to indicate the number of valid storage array entries between a first storage array entry corresponding to the allocation pointer and a second storage array entry corresponding to a retired call operation.

14. The system of claim 13 further comprising an AND logic to perform a Boolean AND operation between the mask and a column of storage entries selected by the top-of-stack pointer.

15. The system of claim 14 further comprising an OR logic to perform a Boolean OR operation between values generated by the AND operation.

16. The system of claim 15, wherein if the result of the OR operation is a first value, the return instruction pointer is to be retrieved from the SRSB, and wherein if the result of the OR operation is a second value, the return instruction pointer is to be retrieved from the CRSB.

17. A method comprising:
indexing a row of an M×N array and writing a committed top-of-stack (CTOS) pointer value to the row;
generating a mask vector, the entries of which indicate the distance between the row indexed and a retire pointer, which indicates a most recently retired call operation;
selecting a column of the M×N array corresponding to the location of the CTOS value.

18. The method of claim 17 further comprising performing a Boolean AND operation between the mask vector entries and the entries of the selected column of the M×N array.

19. The method of claim 18 further comprising performing a Boolean OR operation between the entries of the result of the AND operation.

20. The method of claim 19, wherein if the OR operation results in a first value, then a desired return instruction pointer is retrieved from a speculative return stack buffer (SRSB).

21. The method of claim 20, wherein if the OR operation results in a second value, then the desired return instruction pointer is retrieved from a committed return stack buffer (CRSB).

22. The method of claim 17 wherein the M×N array has the same number of rows and columns.

23. The method of claim 17 wherein the M×N array has a different number of rows and columns.

24. A machine-readable medium having stored thereon a set of instructions, which if executed by a machine cause the machine to perform a method comprising:
performing a speculatively predicted function call;
storing a return instruction pointer into a speculative return stack buffer (SRSB), the return instruction pointer corresponding to a location in program order to which program execution is to return after a return operation is performed within the function called by the function call;
storing the return instruction pointer into a committed return stack buffer (CRSB) after the function call retires;
mapping the location of the return instruction pointer within the SRSB to a corresponding location within the CRSB.

25. The machine-readable medium of claim 24 wherein the return instruction pointer location within the SRSB is mapped to the corresponding location in the CRSB using a two dimensional array, the rows of which correspond to the SRSB entries and the columns of which correspond to the CRSB entries.

26. The machine-readable medium of claim 25 further comprising indexing a row of the array and writing a committed top-of-stack (CTOS) pointer value to the row to indicate that the return instruction pointer is to be stored within the CRSB.

27. The machine-readable medium of claim 26 further comprising generating a mask vector, the entries of which indicate the distance between the row indexed and a retire pointer, which indicates a most recently retired call operation.

28. The machine-readable medium of claim 27 further comprising selecting a column of the array corresponding to the location of the CTOS value.

29. The machine-readable medium of claim 28 further comprising performing a Boolean AND operation between the mask and a column of storage entries selected by the CTOS value.

30. The machine-readable medium of claim 29 further comprising performing a Boolean OR operation between values generated by the AND operation.
